(19) United States
(12) Patent Application Publication
(10) Pub. No.: US 2023/0351532 A1
(43) Pub. Date: Nov. 2, 2023

(54) CUSTOMER AND VENDOR ENGAGEMENT SYSTEMS AND METHODS

(71) Applicant: Tracey Paul, Arvada, CO (US)

(72) Inventor: Tracey Paul, Arvada, CO (US)

(21) Appl. No.: 18/140,436

(22) Filed: Apr. 27, 2023

Related U.S. Application Data
(60) Provisional application No. 63/335,247, filed on Apr. 27, 2022.

(51) Int. Cl. G06Q 50/16; G06Q 30/0207; G06Q 30/0601

(52) U.S. Cl. CPC G06Q 50/167; G06Q 30/0207; G06Q 30/0627; G06Q 2220/00

(57) ABSTRACT

A customer and vendor engagement system and/or method includes a client-facing website providing product information of interest to a plurality of customers and vendor information, customer information and contract databases, each in operable connection with the client-facing website. The vendor information database stores information related to a plurality of vendors, receives vendor information related to the products of information of interest from vendors and selectively shares the vendor information through the client-facing website. The customer information database stores information related to customers, received customer information from a customer having interest in one of the vendors, and selectively shares the vendor information through the customer-facing website. The contract database stores (smart) contract documentation between a selected vendor and the customer, enables the customer to execute the contract, stores the executed contract, releases additional information to the customer and releases the customer's name to the selected vendor. Other embodiments are also disclosed.

### CROSS-REFERENCE TO RELATED APPLICATION

This application claims the benefit under 35 U.S.C. 119 (e) of U.S. Provisional Patent Application Ser. No. 63/335,247, filed Apr. 27, 2022, entitled Customer and Vendor Engagement Systems and Methods, which is incorporated herein by reference.

### BACKGROUND

Generally, it is well understood, routine and conventional for real estate professionals to pay companies like Zillow®, Realtor.com®, and other similar of companies thousands of dollars per months for customer leads. Through that process the real estate professional is notified that a person has provided their information, phone number and email address, and is interested in a property. Once the real estate professional receives that notice, time is of the essence. The sooner the real estate professional calls the lead, the better his or her chances of capturing and converting the lead. Under such a process, a number of real estate professionals pay for the same leads and receive the same alert, which creates a surge of solicitation within seconds, to the consumer that has, just, provided their information. The real estate professionals that try and do not connect with the lead initially will typically continue to follow up and try to connect and convert the lead, for several days, and sometimes, several weeks after the initial alert, though phone calls, emails and texts. This typically results in unreasonable, unwanted, and/or overly intrusive solicitation of the consumer. This process typically results in a lead conversion rate of about one percent.

Another well understood, routine and conventional option for real estate professional leads is through a service providing real estate professional access to pre-screened real estate leads, such as through Realtor.com® (a service previously known as Opcity™ for brokers and agents). Other companies also employ this model. Under this model, the service employs a team of people to prequalify leads, and once a lead is pre-qualified, the service passes that lead along to a real estate professional, for a commission, typically thirty to thirty-five percent of the real estate professional's commission, once a resulting transaction is closed. Through this process, the consumer must provide their personal information, phone number, email address and the like, in turn being solicited. This option is better for the real estate professional as he or she is provided a prequalified lead, but for a premium. Through this process, the lead conversion rate is typically about four percent.

These types of well understood, routine and conventional lead generating platforms cater directly to the real estate professional and make the real estate professional the priority. However, the results are intrusive and bothersome to the consumer in terms of being solicited and sharing of their private information (or at least not readily available information).

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Some embodiments provide a customer and vendor engagement system, this system includes a client-facing website providing product information of interest to a plurality of customers. The client-facing website may have an initial browsing configuration, a post-engagement configuration, and/or further configurations. A vendor information database is in operable connection with the client-facing website. The vendor information database may be configured to store information related to a plurality of vendors, to receive vendor information related to the product information of interest from each of the plurality of vendors enrolled in the vendor information database, and to selectively share the vendor information through the client-facing website. A customer information database is also in operable connection with the client-facing website. The customer information database may be configured to store information related to a plurality of customers, to receive customer information from a customer having interest in one of the plurality of the vendors, and to selective share the vendor information through the customer-facing website. A contract database is also in operable connection with the client-facing website, the contract database may be configured to store contract documentation between a customer-selected one of the plurality of vendors and the customer, to enable or otherwise allow the customer to execute the contract, to store the contract executed by the customer, to release additional information about the customer-selected one of the plurality of vendors to the customer, and to release the name of the customer to the customer-selected one of the plurality of vendors.

Some embodiments provide a method of engagement using a customer and vendor engagement system. This method may provide product information of interest to a plurality of customers, via a client-facing website. This client-facing website may have an initial browsing configuration, a post-engagement configuration and/or further configurations. The method may implement a vendor information database in operable connection with the client-facing website. The vendor information database may store information related to a plurality of vendors, may receive vendor information related to the products of information interest from each of the plurality of vendors enrolled in the vendor information database, and may selectively share the vendor information through the client-facing website. The method may also implement a customer information database in operable connection with the client-facing website. The customer information database may store information related to a plurality of customers, may receive customer information from a customer having interest in one of the plurality of the vendors, and may selectively share the vendor information through the customer-facing website. The method may also provide a contract database in operable connection with the client-facing website. The contract database may store contract documentation between a selected one of the plurality of vendors and the customer, may enable or otherwise allow the customer to execute the contract, may store the contract executed by the customer, may release additional information about the customer-selected one of the plurality of vendors to the customer, and may release the customer's name to the selected one of the plurality of vendors.

In some embodiments, the product information of interest to the plurality of customers is real estate listing information and the information related to the plurality of vendors is real estate agent information.

In some other embodiments, the product information of interest to the plurality of customers is insurance information and the information related to the plurality of vendors is insurance company information.

In some still further embodiments, the product information of interest to the plurality of customers is auto sales information and the information related to the plurality of vendors is auto sales company and/or salesman information.

In some other further embodiments, the product information of interest to the plurality of customers is healthcare and/or healthcare insurance information and the information related to the plurality of vendors is health care company and/or healthcare insurance (company) information.

Other embodiments are also disclosed.

Other objects, features, and advantages of the invention will become apparent from the following detailed description of the invention with reference to the accompanying drawings. That is, additional objects, advantages and novel features of the technology will be set forth in part in the description which follows, and in part, will become more apparent to those skilled in the art upon examination of the following, or may be learned from practice of the technology.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified. Illustrative embodiments of the invention are illustrated in the drawings, in which:

FIG. 1 is a block diagram illustration of an example of a customer and vendor engagement system, according to some embodiments;

FIG. 2 is a flowchart of an example of a customer and vendor engagement process, according to some embodiments;

FIG. 3 illustrates a graphical user interface (GUI) of an exemplary client-facing website, according to some embodiments;

FIG. 4 illustrates a GUI of exemplary steps, and associated display features, such as after the “FIND YOUR AGENT” button is invoked by a user, according to some embodiments; and

FIG. 5 illustrates a GUI of the exemplary steps, and associated display features, of the contracting structure during the signing of the contract by the customer, according to some embodiments.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Embodiments of the present systems and methods are generally related to vendor referrals and directed to customer (buyers or sellers) and vendor engagement systems and methods. Embodiments of the present systems and methods may be practiced by an operator as a web based, vendor (e.g., real estate agent) referral platform. Embodiments of the present systems and methods stop unwanted and costly solicitation and empower the consumer. By doing so, a layer of trust is established with the customer's vendor (e.g., realtor) of their choice. Embodiments of the present systems and methods add the consumer to the vendor referral arrangement, and rewards the consumer for choosing an agent through the present platform embodying the present systems and methods.

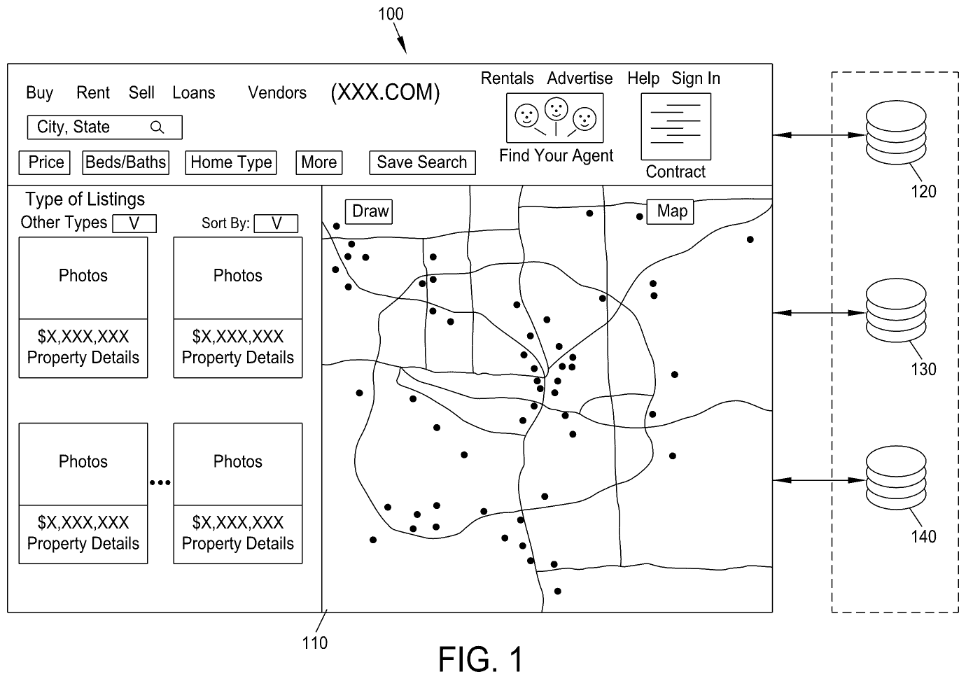

FIG. 1 is a block diagram illustration of example customer and vendor engagement system 100, according to some embodiments. Therein, customer and vendor engagement system 100, in various embodiments includes client-facing website 110 providing product information of interest to a plurality of customers, such as, by way of example, a customer and real estate agent engagement system may include a client-facing website providing real estate listing information and real estate agent information for access by a plurality of customers. Client-facing website 110 may have an initial browsing configuration, one or more (sequential) engagement configurations, and/or a post-engagement configuration.

Customer and vendor engagement system 100 may also include vendor information database 120 in operable connection with client-facing website 110, such as, for example a customer and real estate agent engagement system may include a real estate agent information database in operable connection with the client-facing website. Vendor information database 120 may be configured to store information related to a plurality of vendors, such as, by way of example, a real estate agent information database may be configured to store information related to a plurality of real estate agents. Vendor information database 120 may also be configured to receive vendor information related to the products of information interest from each of the plurality of vendors enrolled therein, such as, for example, a real estate agent information database may be configured to receive real estate agent information from each of the plurality of real estate agents to enroll each real estate agent in the real estate agent information database.

For example, initial signup by a vendor (e.g., real estate agent) may, by way of example involve following a QR code, or the like to a website operated by an entity practicing the present systems and methods to submit the vendor's name and email address. This may lock in the vendor's signup date. This signup date may be used as a means to sort vendors by seniority on the present platform. Prior to launch, vendors may be invited to create a profile and receive a customizable widget. This widget may be a web widget or mobile web widget. When connecting through the vendor's widget, a customer is lead directly to a vendor's (e.g., real estate agent's) profile. in accordance with embodiments of the present systems and methods the vendor's widgets can be shared and promoted across digital platforms.

Vendor information database 120 may also be configured to selectively share the vendor information through client-facing website 110, such as, by way of example, the real estate agent information database selectively sharing (a portion of) the real estate agent information through the client-facing website.

Customer and vendor engagement system 100 may also include customer information database 130 in operable connection with client-facing website 110, such as, for example, the aforementioned customer and real estate agent engagement system may include a customer information database in operable connection with the client-facing website. Customer information database 130 may be configured to store information related to a plurality of customers, such as, by way of example, the real estate customer information database being configured to store information related to a plurality of real estate customers. Customer information database 130 may be further configured to receive customer information from a customer having interest in one of the plurality of the vendors, such as, for example, the real estate customer information database receiving customer information from a customer having interest in one of the plurality of the real estate agents. Customer information database 130 may also be configured to selectively share the vendor information through customer-facing website 110, such as, by way of example, the real estate customer information database selectively sharing (a portion of the) real estate agent information through the customer-facing website.

Customer and vendor engagement system 100 may also include contract database 140 in operable connection with client-facing website 110, for example, a customer and real estate agent engagement system may include such a contract database in operable connection with the client-facing website. Contract database 140 may be configured to store contract documentation between a selected one of the plurality of vendors and a customer, such as, by way of example, the customer and real estate agent engagement system contract database may store contract documentation between a customer-selected one of the plurality of real estate agents and the customer. Contract database 140 may also be configured to allow the customer to sign the contract, such as, for example, the customer and real estate agent engagement system contract database may enable the customer to execute the contract. Contract database 140 may be further configured to store the contract signed by the customer, such as for example the customer and real estate agent engagement system contract database may be configured to store such a contract executed by the customer. This contract may act as a smart engagement contract. This is a legal and binding contract between the customer, the agent (vendor), and the operator of the customer and vendor engagement system and method. Alternatively, embodiments of the present systems and methods may make use of (two) separate (smart) two-party contracts. A first two-party (smart) contract, may be between the real estate agent (vendor) and the operator of the customer and vendor engagement system and method, such as may be executed during enrollment of the agent in the present customer and vendor engagement system and method. A second (smart) two-party contract may be between the customer-selected real estate agent (vendor) and the customer. The mutually executed smart engagement contract(s) will, in course, be uploaded, or otherwise provided for closing, with all other documents for disbursement of funds at title when a successful closing occurs.

Additionally, these smart contract(s), or at least the contract (portion) between the vendor (real estate agent) and the customer, may include a “disengagement contract” (or provision), in which the customer releases liability of parties before engaging with a new vendor (real estate agent). For example, in accordance with various embodiments of the present systems and methods, the customer may be called upon to disengage with a (prior) vendor (real estate agent) (engaged under embodiments of the present systems and methods) before engaging a new vendor (real estate agent) (under embodiments of the present systems and methods).

In accordance with embodiments of the present systems and methods, the smart contract may be a “smart legal contract” which is a legally-binding agreement that has (selected) terms expressed and implemented in machine-readable code to implement a transaction protocol that is intended to automatically execute, control or document events and actions according to the terms of the engagement contract. In certain embodiments the smart legal contract may be, or include, a clickwrap, also known as click-accept, click-to-sign, or clickthrough, agreement (portion(s)), or the like, as discussed below. A clickwrap is an online agreement that users agree to by clicking an “I agree” button or checking an “I agree” box, or the like. The act of signing via an electronic signature is replaced with the act of clicking. Alternatively, or additionally, such agreement (portion(s)) may include a “sign-in-wrap,” (where clicking “register” or “sign-in” constitutes acceptance to the terms) and/or a browsewrap (where using the site indicates acceptance of terms).

Contract database 140 may also be configured to release additional information to the customer, such as by way of example, the customer and real estate agent engagement system contract database may release additional information about the customer-selected agent to the customer, in response to execution of the contract by the customer. Contract database 140 may be further configured to release the name of the customer to the selected one of the plurality of vendors, such as, for example, the customer and real estate agent engagement system contract database may also release the customer's name to the selected real estate agent, in response to execution of the contract by the customer.

In operation, embodiments of the present systems and methods enable a user consumer to search for a vendor (e.g., real estate agent) through filters provided on the client-facing website and choose a vendor. Once a vendor is chosen, the consumer is prompted to review a contract that explains the rebate (discussed in greater detail below) that the consumer will receive (upon closing). After the consumer signs the contract, the vendor is notified through email, text, push notification, or the like, that they have been engaged with a customer in accordance with the present systems and methods. At that point the vendor can expect a call, text or email from the customer. Consumers may be afforded an ability to share properties with their agent through the present platform if they desire. Thereby, embodiments of the present systems and methods, provide customer and vendor engagement communication, without solicitation.

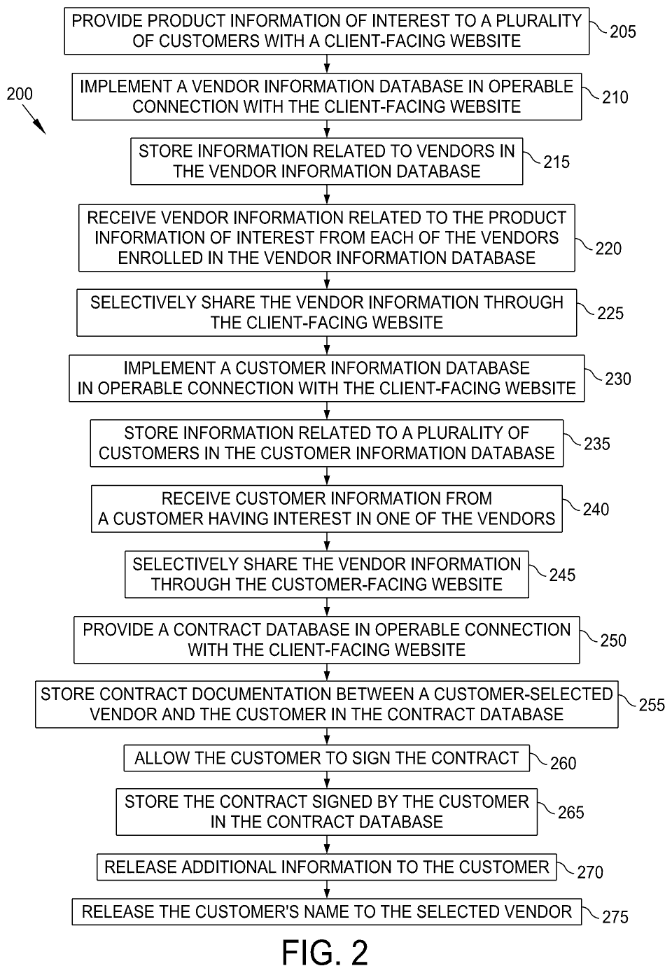

FIG. 2 is a flowchart of example customer and vendor engagement process 100, according to some embodiments. Therein, at 205, product information of interest to a plurality of customers may be presented using a client-facing website (110). For example, real estate listing information and real estate agent information may be presented at 205, via a client-facing website, for access by a plurality of customers. This client-facing website may have an initial browsing configuration, one or more (sequential) engagement configurations, and/or a post-engagement configuration.

At 210, a vendor information database (120) may be implemented, in operable connection with the client-facing website, such as, for example, implementing a real estate agent information database in operable connection with the client-facing website, at 210. At 215, information related to a plurality of vendors is stored with the vendor information database, such as, by way of example, by storing information related to each of a plurality of real estate agents in the real estate agent information database, at 215. At 220, vendor information related to the products of information of interest is received from each of the plurality of vendors enrolled therein with the vendor information database. For example, each of the plurality of real estate agents may be enrolled in the real estate agent information database, and thereby in accordance with embodiments of the present systems and methods, by receiving real estate agent information from each of the plurality of real estate agents, at 220. At 225, (a portion) of the vendor information is (selectively) shared through the client-facing website with the vendor information database, such as, by way of example, selectively sharing real estate agent information through the client-facing website, from the real estate agent information database, at 225.

At 230, a customer information database (130) is implemented in operable connection with the client-facing website, such as for example, by implementing a customer information database in operable connection with the client-facing website, a 230. At 235, information related to a plurality of customers is stored with the customer information database, such as, by way of example, by storing information related to each of a plurality of customers in the customer information database, at 235. At 240, customer information is received from a customer having interest in one of the plurality of the vendors with the customer information database, such as, for example, by receiving, by the customer information database, customer information from a customer having interest in one of the plurality of the real estate agents, at 240. At 245, (more of) the vendor information is selectively shared through the customer-facing website by the customer information database, such as, by way of example, by the customer information database selectively sharing the information related to the one real estate agent, through the customer-facing website, at 245.

At 250 a contract database (140) is implemented in operable connection with the client-facing website. At 255, contract documentation between a selected one of the plurality of vendors and the customer is stored with the contract database, such as, for example, by storing contract documentation between a selected one of the plurality of real estate agents and the customer, in the contract database, at 255. At 260, the contract database allows (e.g., enables) the customer to sign (execute) the contract, such as, by way of example, enabling the customer to execute the contract in the contract database, at 260. At 265, the contract signed by the customer is stored with the contract database. At 270, additional information is released to the customer with the contract database, for example, additional information about the selected real estate agent, such as the agent's phone number and/or email address, may be released to the customer, from the contract database, at 270, in response to execution of the contract by the customer at 260. At 275, the customer's name is released to the selected one of the plurality of vendors, with the contract database, such as, for example, by releasing the customer's name to the selected one of the plurality of real estate agents from the contract database, at 275, also in response to execution of the contract by the customer at 260.

Embodiments of the present systems and methods for customer and vendor engagement are described herein, in examples above and particularly below, in terms of a customer, which may be a consumer or other customer, and a real estate professional, such as a real estate agent. Thus, in some embodiments, the product information of interest to the plurality of customers may be real estate listing information and the information related to the plurality of vendors may be real estate agent information. However, in some other embodiments, the product information of interest to the plurality of customers may be insurance information and the information related to the plurality of vendors may be insurance company information. In some still further embodiments, the product information of interest to the plurality of customers may be auto sales information and the information related to the plurality of vendors may be auto sales company and/or salesman information. In some other further embodiments, the product information of interest to the plurality of customers may be healthcare and/or healthcare insurance information and the information related to the plurality of vendors may be health care company and/or healthcare insurance (company) information.

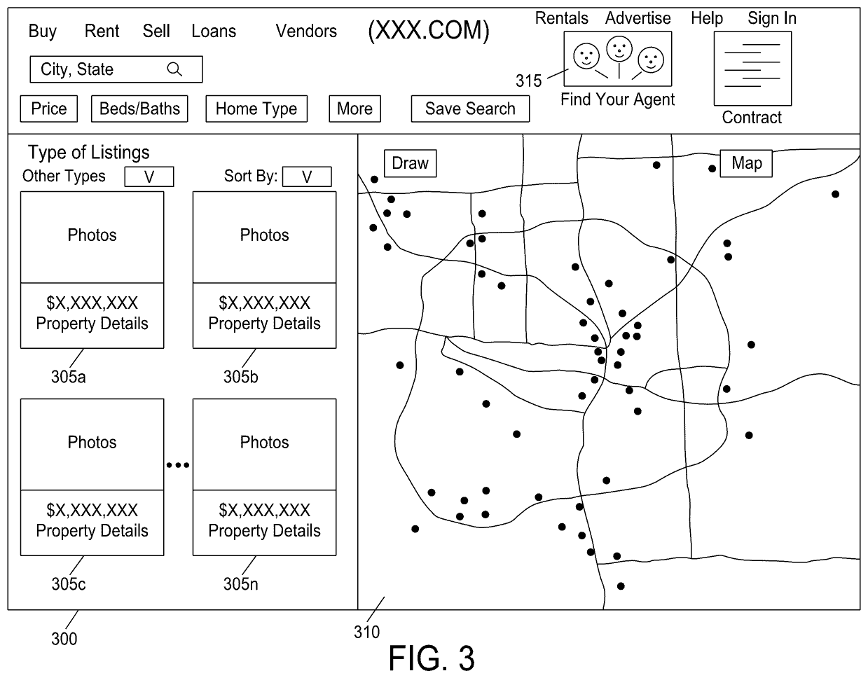

In accordance with various real estate-oriented embodiments of the present systems and methods, (a) client-facing website(s) may be provided that includes features similar to Zillow®, Realtor.com®, Redfin®, and other similar real estate websites. While each of these websites typically use old ways of connecting real estate professionals to leads that are well understood, routine and conventional in the industry, embodiments of the present systems and methods provide customer and vendor engagement in a new manner that is not well understood, routine and conventional in the industry. For example, FIG. 3 illustrates example graphical user interface (GUI) 300 of an exemplary client-facing customer and vendor engagement website, according to some embodiments. Website 300 is shown in an initial browsing configuration, for real estate engagement with properties 305a-n within geographical area 310, and real estate professionals associated with the geographical area being selectively available using “find your agent” button 315. In various embodiments, buyers may search for homes on client-facing website 300 and find a property of interest (e.g., one of 305a-n), which may include or result in one or more of the following, finding out more information about the property, going to see the property, and putting an offer in on the property. After any of which, the buyer (or seller) may, in accordance with embodiments of the present systems and methods, select the box “Find Your Agent” 315.

In various embodiments, the client-facing website, agent drop down box, and the like may relate to other items of interest to a customer, professional services, and the like, and may be referred to as product information of interest, vendor information, and the like.

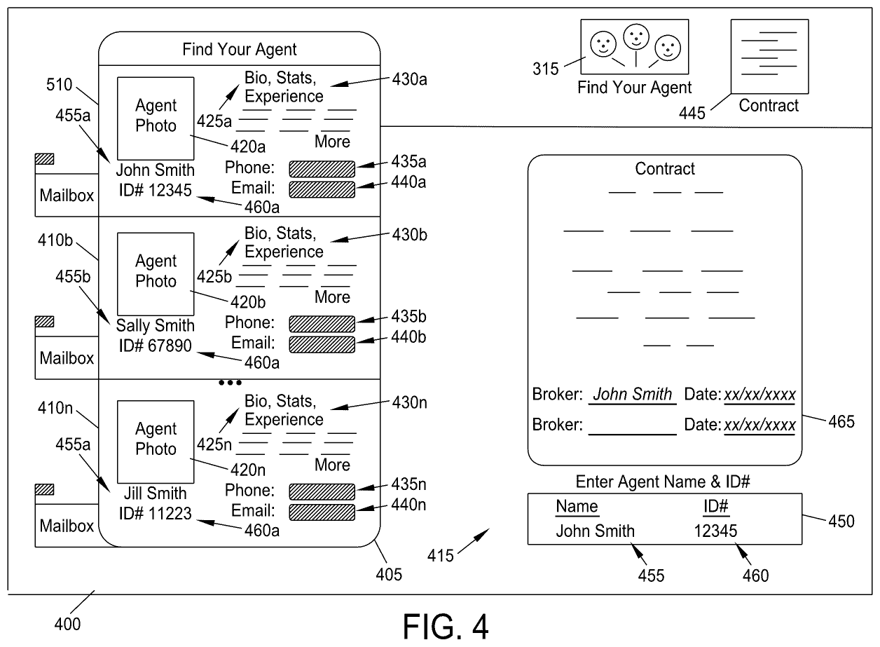

In at least some embodiments, once “Find Your Agent” button 315 is selected, the customer may personally research as many agents as desired, and then decide on which agent suits their needs. To wit, FIG. 4 illustrates a graphical user interface (GUI) 400 of exemplary steps, associated display features, and the like, presented after “FIND YOUR AGENT” button 315, or the like is invoked by the customer. GUI 400 includes pop-up selectable menu 405 of multiple real estate agents 410a-n, for choosing one agent, from the agents. GUI 400 also includes contracting forming input area 415, which enables the customer to finalize the selection and engagement of the real estate professional, to finalize a payment structure to the real estate professional, to the website platform, and to the customer (as a rebate, as discussed above, and below) during the engagement process.

Agent drop down box 405 may provide a platform for the real estate agents to advertise themselves (photo 420a-n, bio 425a-n, statistics 430a-n, etc.) and set their profile apart from other agents for a economical monthly fee (in contrast to spending thousands to tens of thousands of dollars per month for potential leads that may or may not provide a return, and wherein the agent needs to act immediately to see best results with a one to four percent typical return rate.)

In order for a real estate agent to join the website platform for the present customer and vendor engagement system, he or she agrees to the terms and conditions of the platform. Once the real estate agent agrees to the terms and conditions, the website may prompt the agent to the next step, which presents the agent with a legal and binding contract to bind the real estate agent to each of the customer and the website. Alternatively, as noted, embodiments of the present systems and methods may make use of (two) separate (smart) two-party contracts. A first two-party (smart) contract, may be between the real estate agent and the operator of the customer and vendor engagement system and method, such as may be executed during enrollment (220) of the agent in the present customer and vendor engagement system and method. A second (smart) two-party contract may be between the customer-selected real estate agent and the customer. In various embodiments, the contract(s) state(s) that all parties agree to the contract and through the contract process the real estate agent is agreeing to upload this (these) contract(s) to the title company and agrees to treat the contract(s) in the same manner as other documents which are part of the transaction. The contract(s) state(s) that once a transaction is closed, the real estate agent, at that time, will pay a commission (typically through the title company as funds are dispersed) to each of the website platform for the lead and the customer (as a rebate) for choosing a real estate agent. Once the realtor reads and agrees to the contract(s), the agent will sign and the contract(s) (at least the contract between the agent and the customer) will be available to the customer.

The real estate agent's information, except for the agent's phone number 435a-n, email address 440a-n and the like, which may be redacted/blurred at this point, is all visible and easily able to be read through. In order for the customer to gain access to the real estate agent's phone number and email address, the customer will invoke “contract” icon 445.

Once the customer clicks on contract icon 445, the customer may be prompted with a search bar 450, or the like, where the customer may enter the real estate agent's name 455 and ID code 460a-n, as provided on the real estate agent's pop-up menu 415 profile 410. The agent ID 460 may have in accordance with embodiments of the present systems and methods been previously generated by the website platform when the real estate agent initially signs up for participation in the in present customer and vendor engagement system (215, 220), as described above.

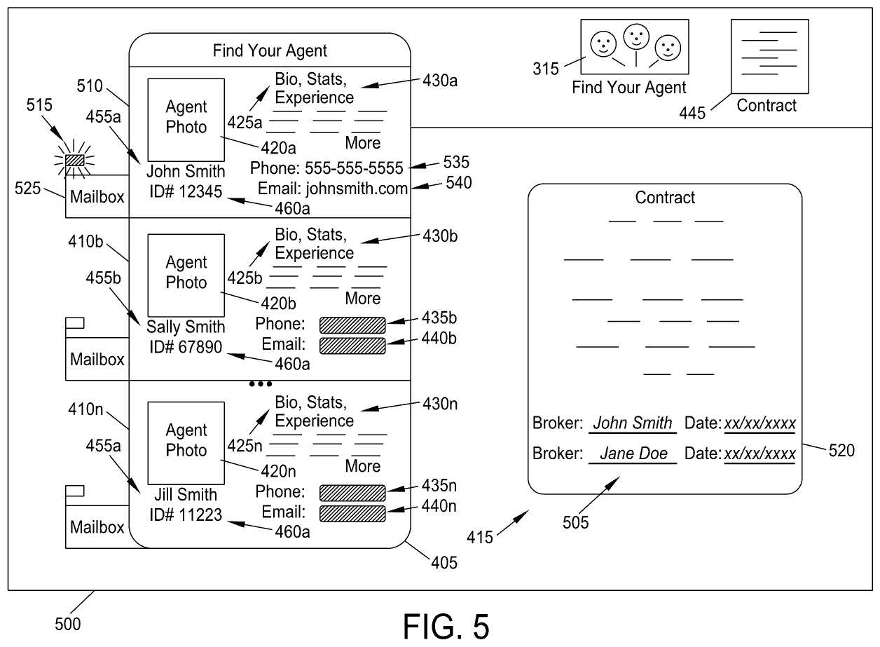

Once the customer enters the real estate agent's information in search bar 445, and presses enter, signed contract 465 from the real estate agent appears in GUI 400. Contract 465 may be a smart contract, which as discussed above, may be, or include, (a) clickwrap agreement (portion(s)), or the like. Once the customer reads through real estate agent-signed contract 465, agrees with the terms and desires to proceed, the customer signs the contract (and in various embodiments only the name of the customer is required, without any phone number or email address necessary), as illustrated in FIG. 5.

FIG. 5 illustrates GUI 500 of exemplary steps, and associated display features, of the contracting structure during execution (signing (and dating)) 505 of the contract by the customer, according to some embodiments, which, as discussed above, may be, or include, (a) clickwrap agreement (portion(s)), or the like. For example, GUI 500 displays the full record available of agent information 510 to the customer, and an agent alert notification 515 to the agent regarding signed contract 520, with a copy of the signed contract delivered to agent's mailbox 525. In accordance with embodiments of the present systems and methods an auto-alert, such as discussed below, may be issued to the agent (and the customer), such as upon the customer completing execution of contract 520. In accordance with embodiments of the present systems and methods and the foregoing, a referral lead generated via customer executed and delivered (smart) contract 520.

As discussed above, various embodiments of the present systems and methods may make use of (two) separate (smart) two-party contracts. A first two-party (smart) contract, may be between the real estate agent and the operator of the customer and vendor engagement system and method, such as may be executed during enrollment (220) of the agent in the present customer and vendor engagement system and method. A second (smart) two-party contract (e.g., contract 520) may be between the customer-selected real estate agent and the customer.

Resultingly, all of the parties are bound by contract 520, the real estate agent, the website platform owner and the customer. Once contract 520 is in the real estate agent's mailbox 525, two things happen in accordance with embodiments of the present systems and methods. First, the real estate agent will receive (auto) alert 515 that a signed contract is in their mailbox. This alert (and/or an accompanying automatic alert, such as an email, push notification, or the like) lets the agent know they can expect a call from the customer. Under various embodiments of the present systems and methods, only the name of the customer is provided to the agent. Second, and simultaneously, once contract 520 has sent to the real estate agent's mailbox 525 binding all the parties, the real estate agent's phone number 535 and email address 540 now become visible to the customer, and the customer may now contact the real estate agent at his or her convenience.

Upon closing, contract 520 is satisfied and the customer's agent fulfills their obligations to the customer, and an operator of the present systems and methods. These obligations may include include a percentage referral fee of their (buyer's) commission to the operator of the present systems and methods, by way of example a twenty-five percent referral fee, and a (fixed) fee (i.e., rebate) to the customer, by way of example a one-thousand dollar rebate to the customer. These obligations are separate and apart from any imposed by their brokerage, but only occur once a commissioned sale has closed.

By using the contract process and system of the present customer and vendor engagement systems and methods, as described, payment to all parties (e.g., the real estate agent, the website platform owner or operator, and the customer (buyer or seller)) is guaranteed (i.e., contract mandated), and the real estate agent is prevented from trying to exclude the website platform from the transaction. Even if a real estate agent tries to entice the customer by paying the customer more than contract 520′s customer commission and the customer accepts, as long as the customer enforces the contract the real estate agent will be compelled to pay the commission to the website and the customer as stated in (smart) website contract 520.

The resulting contracting process, to payment apportionment, puts the customer in control of their entire online experience without having to provide any of their personal information, email address, and phone number, so as to therefore eliminate the immediate and long term solicitation from numerous real estate agents, and other industry solicitors, through phone calls, texts, and emails as a result of these real estate agents and other solicitors paying for the same leads, as is well understood, routine and conventional in the industry. Further, embodiments of the present systems and processes of contracting through payment apportionment provides money to the customer, a rebate, in a new manner. Thusly, not only does the customer avoid the need to provide personal information (i.e., email address, phone number), embodiments of the present systems and methods, solicitation from countless real estate agents (or other salespeople, brokers, or other transaction experts) is eliminated, as well as high pressure sales calls, and/or personal information is not sold. In accordance with embodiments of the present systems and methods, the customer searches for a professional of their choice and will not receive calls from random professionals. Also, under embodiments of the present systems and methods, the customer has the ability to choose a different professional if the one selected (at 500) is not who the customer ultimately desires to sign working relationship documents outside of the contract agreed upon on the website with. Additionally, as noted, money is provided to the customer at closing, in the form of a rebate, or the like. Thus, control is put in the hands of the customer, which is not routine and conventional in the industry. Thusly, a higher level of service is provided for the customer; and there is an all-around better experience for the customer.

Advantages to the real estate professional (or other professional in other situations) include the elimination of high monthly lead costs; elimination of hours of cold calling; provision of another platform for real estate professionals to advertise themselves and get their name and brand seen; the real estate professional spends zero time for any and all leads that come from the site so as to free up their time to focus on other parts of their business; the return rate on actual leads dramatically goes up; the real estate professional pays for leads after the transaction closes, in turn only paying for real leads; levels the playing field for all real estate professionals inasmuch as real estate professionals that could not afford to buy leads now have the same opportunity as the real estate professional that could afford to spend tens for thousands of dollars on leads per month; and elevating the quality and service of the real estate business as a whole, in contrast to real estate professionals that have gotten comfortable though having the ability to pay for leads will now have to compete with the potentially more competitive newer agents that will now have the same opportunities.

In various embodiments, the customer and vendor engagement model may be used with a wide array of companies and industries. For example, industries may include, but are not limited to, insurance companies, auto sales companies, healthcare companies, etc.

In accordance with the foregoing, embodiments of the present systems and methods provide an improvement in the functioning of customer and vendor engagement computer systems, as well improvement to other the technical field of online customer and vendor engagement. Embodiments of the present systems and methods may, in accordance with the foregoing, be implemented with, or used in conjunction with, a particular purpose-built customer and vendor engagement system that is integral to provisioning of the customer and vendor engagement. Regardless, embodiments of the present systems and methods employ specific steps other than what is well-understood, routine, conventional activity in the field of customer and vendor engagement, and employs unconventional steps that confine the claim to a particular useful application of online customer and vendor engagement.

When elements are referred to as being “connected” “coupled,” or the like (e.g., in operable connection) the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

In various embodiments, aspects of systems and methods described herein may be implemented, at least in part, using machine learning (ML) and/or Artificial Intelligence (AI). For example, various determinations on information to share, vendors to identify, enforcement of smart contract terms, tracking via blockchain, etc. may be carried out in accordance with embodiments of the present systems and methods using ML and/or AI. As used herein, the terms “machine learning” or “ML” refer to one or more algorithms that implement: a neural network (e.g., artificial neural network, deep neural network, convolutional neural network, recurrent neural network, autoencoders, reinforcement learning, etc.), fuzzy logic, AI, deep learning, deep structured learning hierarchical learning, support vector machine (SVM) (e.g., linear SVM, nonlinear SVM, SVM regression, etc.), decision tree learning (e.g., classification and regression tree or “CART”), Very Fast Decision Tree (VFDT), ensemble methods (e.g., ensemble learning, Random Forests, Bagging and Pasting, Patches and Subspaces, Boosting, Stacking, etc.), dimensionality reduction (e.g., Projection, Manifold Learning, Principal Components Analysis, etc.), or the like.

Non-limiting examples of publicly available machine learning algorithms, software, and libraries that may be utilized within embodiments of systems and methods described herein include, but are not limited to: PYTHON, OPENCV, INCEPTION, THEANO, TORCH, PYTORCH, PYLEARN2, NUMPY, BLOCKS, TENSORFLOW, MXNET, CAFFE, LASAGNE, KERAS, CHAINER, MATLAB Deep Learning, CNTK, MatConvNet (a MATLAB toolbox implementing convolutional neural networks for computer vision applications), DeepLearnToolbox (a Matlab toolbox for Deep Learning from Rasmus Berg Palm), BigDL, Cuda-Convnet (a fast C++/CUDA implementation of convolutional or feed-forward neural networks), Deep Belief Networks, RNNLM, RNNLIB-RNNLIB, matrbm, deeplearning4j, Eblearn.Ish, deepmat, MShadow, Matplotlib, SciPy, CXXNET, Nengo-Nengo, Eblearn, cudamat, Gnumpy, 3-way factored RBM and mcRBM, mPoT, ConvNet, ELEKTRONN, OpenNN, NEURALDESIGNER, Theano Generalized Hebbian Learning, Apache SINGA, Lightnet, and SimpleDNN.

The computer-usable or computer-readable medium, such as may be referred to herein as non-transitory computer-readable storage medium, or the like, may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A customer and real estate agent engagement system, the system comprising:
a client-facing website providing real estate information for access by a plurality of customers;
a real estate agent information database in operable connection with the client-facing website, the real estate agent information database configured to:
store information related to a plurality of real estate agents;
receive real estate agent information from each of the plurality of real estate agents to enroll each real estate agent in the real estate agent information database; and
selectively share the real estate agent information through the client-facing website;
a customer information database in operable connection with the client-facing website, the customer information database configured to:
store information related to a plurality of customers;
receive customer information from a customer having interest in one of the plurality of the real estate agents; and
selectively share the real estate agent information through the customer-facing website; and
a contract database in operable connection with the client-facing website, the contract database configured to:
store contract documentation between a customer-selected one of the plurality of real estate agents and the customer;
enable the customer to execute the contract;
store the contract executed by the customer;
release additional real estate agent information to the customer; and
release the customer's name to the selected one of the plurality of real estate agents.

2. The customer and real estate agent engagement system of claim 1, wherein the client-facing website has an initial browsing configuration prior to execution of the contract by the customer, one or more (sequential) engagement configurations, and a post-engagement configuration following execution of the contract by the customer.

3. The customer and real estate agent engagement system of claim 1, wherein the contract database is further configured to issue a rebate to the customer upon closing of a real estate contract brokered by the selected one of the plurality of real estate agents.

4. The customer and real estate agent engagement system of claim 1, wherein the real estate information is real estate listing information and real estate agent information.

5. The customer and real estate agent engagement system of claim 1, wherein the contact is a smart contract.

6. The customer and real estate agent engagement system of claim 1, further comprising a real estate agent widget configured to direct a customer to a profile of the real estate agent on the client-facing website.

7. The customer and real estate agent engagement system of claim 6, wherein the widget is a web widget.

8. The customer and real estate agent engagement system of claim 6, wherein the widget is a mobile web widget.

9. A method comprising:
presenting, via a client-facing website, real estate information for access by a plurality of customers;
implementing a real estate agent information database in operable connection with the client-facing website;
storing information related to each of a plurality of real estate agents in the real estate agent information database;
receiving real estate agent information from each of the plurality of real estate agents;
enrolling each of the plurality of real estate agents in the real estate agent information database using the real estate agent information from each of the plurality of real estate agents;
selectively sharing real estate agent information through the client-facing website;
implementing a customer information database in operable connection with the client-facing website;
storing information related to each of a plurality of customers in the customer information database;
receiving customer information from a customer having interest in one of the plurality of the real estate agents;
implementing a contract database in operable connection with the client-facing website;
storing contract documentation between a selected one of the plurality of real estate agents and the customer in the contract database;
enabling the customer to execute the contract in the contract database;
storing the contract signed by the customer in the contract database;
releasing additional information to the customer from the contract database; and
releasing the customer's name to the selected one of the plurality of real estate agents from the contract database.

10. The method of claim 9 further comprising presenting the client-facing website in an initial browsing configuration prior to execution of the contract, in one or more engagement configurations during execution of the contract, and in a post-engagement configuration after execution of the contract by the customer.

11. The method of claim 9, further comprising rebating a predetermined amount of money to the customer upon closing of a real estate contract brokered by the one real estate agent.

12. The method of claim 9, wherein the real estate information is real estate listing information and real estate agent information.

13. The method of claim 9, wherein selectively sharing the real estate agent information through the client-facing website comprises not sharing contact information of a real estate agent through the client-facing website.

14. The method of claim 9, wherein releasing additional real estate agent information to the customer comprises releasing an email address of the selected one of the plurality of real estate agents to the customer, via the client-facing website.

15. The method of claim 9, wherein releasing additional real estate agent information to the customer comprises releasing a phone number of the selected one of the plurality of real estate agents to the customer, via the client-facing website.

16. The method of claim 9, wherein the contact is a smart contract.

17. The method of claim 9, further comprising directing, by a widget, the customer to a profile of the real estate agent on the client-facing website.

18. A non-transitory computer-readable storage medium having program instructions stored thereon that, upon execution by one or more computer systems, cause the one or more computer systems to:
present a client-facing website providing real estate real estate listing information and real estate agent information for access by a plurality of customers;
store information related to a plurality of real estate agents;
receive real estate agent information from each of the plurality of real estate agents to enroll each real estate agent in a real estate agent information database; and
selectively share the real estate agent information through the client-facing website;
store information related to a plurality of customers;
receive customer information from a customer having interest in one of the plurality of the real estate agents; and
store contract documentation between a customer-selected one of the plurality of real estate agents and the customer;
enable the customer to execute the contract;
store the contract executed by the customer;
release additional real estate agent information to the customer; and
release the customer's name to the selected one of the plurality of real estate agents.

19. The non-transitory computer-readable storage medium of claim 18, selectively sharing the real estate agent information through the client-facing website comprises not sharing contact information of a real estate agent through the client-facing website.

20. The non-transitory computer-readable storage medium of claim 19 wherein releasing additional real estate agent information to the customer comprises releasing an email address and/or a phone number of the selected one of the plurality of real estate agents to the customer, via the client-facing website.
